(19) United States
(12) Patent Application Publication
(10) Pub. No.: US 2026/0136286 A1
(43) Pub. Date: May 14, 2026

(54) COMMUNICATION CONFIGURATION INDICATION IN A WAKEUP SIGNAL

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/941,021

(22) Filed: Nov. 8, 2024

(51) Int. Cl. H04W 52/02; H04B 7/0413; H04W 72/231; H04W 72/51

(52) U.S. Cl. CPC H04W 52/0235; H04B 7/0413; H04W 72/231; H04W 72/51

(57) ABSTRACT

Various aspects of the present disclosure generally relate to wireless communication. In some aspects, a user equipment (UE) may transmit, to a network node, a wakeup signal (WUS) capability that indicates support for receiving a WUS that indicates a communication configuration that comprises at least one of: a first quantity of uplink (UL) or downlink (DL) multiple-input-multiple-output (MIMO) layers, a second quantity of transmit (TX) or receive (RX) ports, or a main radio PDCCH skip configuration. The UE may receive, from the network node, the WUS that indicates the communication configuration. The UE may communicate with the network node based at least in part on the communication configuration indicated by the WUS. Numerous other aspects are described.

### FIELD OF THE DISCLOSURE

Aspects of the present disclosure generally relate to wireless communication and specifically relate to techniques, apparatuses, and methods associated with a transmission layer indication in a wakeup signal.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include transmitting, to a network node, a wakeup signal (WUS) capability that indicates support for receiving a WUS that indicates a communication configuration that comprises at least one of: a first quantity of uplink (UL) or downlink (DL) multiple-input-multiple-output (MIMO) layers, a second quantity of transmit (TX) or receive (RX) ports, or a main radio physical downlink control channel (PDCCH) skip configuration. The method may include receiving, from the network node, the WUS that indicates the communication configuration. The method may include communicating with the network node based at least in part on the communication configuration indicated by the WUS.

Some aspects described herein relate to a method of wireless communication performed by a network node. The method may include receiving, from a UE, a WUS capability that indicates support for receiving a WUS that indicates a communication configuration that comprises at least one of: a first quantity of UL or DL MIMO layers, a second quantity of TX or RX ports, or a main radio PDCCH skip configuration. The method may include transmitting, to the UE, the WUS that indicates the communication configuration. The method may include communicating with the UE based at least in part on the communication configuration indicated by the WUS.

Some aspects described herein relate to an apparatus for wireless communication at a UE. The apparatus may include one or more memories and one or more processors coupled to the one or more memories. The one or more processors may be configured to transmit, to a network node, a WUS capability that indicates support for receiving a WUS that indicates a communication configuration that comprises at least one of: a first quantity of UL or DL MIMO layers, a second quantity of TX or RX ports, or a main radio PDCCH skip configuration. The one or more processors may be configured to receive, from the network node, the WUS that indicates the communication configuration. The one or more processors may be configured to communicate with the network node based at least in part on the communication configuration indicated by the WUS.

Some aspects described herein relate to an apparatus for wireless communication at a network node. The apparatus may include one or more memories and one or more processors coupled to the one or more memories. The one or more processors may be configured to receive, from a UE, a WUS capability that indicates support for receiving a WUS that indicates a communication configuration that comprises at least one of: a first quantity of UL or DL MIMO layers, a second quantity of TX or RX ports, or a main radio PDCCH skip configuration. The one or more processors may be configured to transmit, to the UE, the WUS that indicates the communication configuration. The one or more processors may be configured to communicate with the UE based at least in part on the communication configuration indicated by the WUS.

Some aspects described herein relate to a non-transitory computer-readable medium that stores a set of instructions for wireless communication by a UE. The set of instructions, when executed by one or more processors of the UE, may cause the UE to transmit, to a network node, a WUS capability that indicates support for receiving a WUS that indicates a communication configuration that comprises at least one of: a first quantity of UL or DL MIMO layers, a second quantity of TX or RX ports, or a main radio PDCCH skip configuration. The set of instructions, when executed by one or more processors of the UE, may cause the UE to receive, from the network node, the WUS that indicates the communication configuration. The set of instructions, when executed by one or more processors of the UE, may cause the UE to communicate with the network node based at least in part on the communication configuration indicated by the WUS.

Some aspects described herein relate to a non-transitory computer-readable medium that stores a set of instructions for wireless communication by a network node. The set of instructions, when executed by one or more processors of the network node, may cause the network node to receive, from a UE, a WUS capability that indicates support for receiving a WUS that indicates a communication configuration that comprises at least one of: a first quantity of UL or DL MIMO layers, a second quantity of TX or RX ports, or a main radio PDCCH skip configuration. The set of instructions, when executed by one or more processors of the network node, may cause the network node to transmit, to the UE, the WUS that indicates the communication configuration. The set of instructions, when executed by one or more processors of the network node, may cause the network node to communicate with the UE based at least in part on the communication configuration indicated by the WUS.

Some aspects described herein relate to an apparatus for wireless communication. The apparatus may include means for transmitting, to a network node, a WUS capability that indicates support for receiving a WUS that indicates a communication configuration that comprises at least one of: a first quantity of UL or DL MIMO layers, a second quantity of TX or RX ports, or a main radio PDCCH skip configuration. The apparatus may include means for receiving, from the network node, the WUS that indicates the communication configuration. The apparatus may include means for communicating with the network node based at least in part on the communication configuration indicated by the WUS.

Some aspects described herein relate to an apparatus for wireless communication. The apparatus may include means for receiving, from a UE, a WUS capability that indicates support for receiving a WUS that indicates a communication configuration that comprises at least one of: a first quantity of UL or DL MIMO layers, a second quantity of TX or RX ports, or a main radio PDCCH skip configuration. The apparatus may include means for transmitting, to the UE, the WUS that indicates the communication configuration. The apparatus may include means for communicating with the UE based at least in part on the communication configuration indicated by the WUS.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A and 3B are diagrams illustrating a first example and a second example of a single-input-single-output system and a multiple-input-multiple-output system, respectively, in accordance with the present disclosure.

FIGS. 4A, 4B, 4C, and 4D are diagrams illustrating, respectively, a first example of a low power wakeup radio, a second example of a low power wakeup signal (LP-WUS), a third example of a first LP-WUS procedure, and a fourth example of a second LP-WUS procedure, in accordance with the present disclosure.

FIG. 5 is a diagram illustrating an example of a wireless communication process between a network node and a user equipment (UE), in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may be equipped with a communication system that includes a main radio (MR) and a low power-wake up radio (LP-WUR) to reduce power consumption and enable low latency. For example, power saving and low latency are often conflicting goals because placing one or more components into a sleep state more often to reduce power consumption also increases latency, and because reducing the time that one or more components spend in a sleep state to reduce latency can lead to increased power consumption. In some cases, the UE may generally use the MR to transmit and/or receive user data, and the MR may be turned off or operated in a deep sleep state unless there is user data to transmit and/or receive. As one example, the UE may operate in a discontinuous reception (DRX) cycle in which the MR alternates between a sleep state and an active state. The LP-WUR may serve as a simple wakeup receiver for the MR, and the LP-WUR may be active and monitoring for a low power-wake up signal (LP-WUS) while the MR is off or in the deep sleep state as described below.

An amount of power consumed by a UE may largely depend on a quantity of communication chains and/or ports that are powered by the UE in the MR. To illustrate, a UE may include multiple communication chains and/or multiple ports to process a respective uplink and/or downlink layer in a multiple-input-multiple-output (MIMO) communication that includes multiple layers. Example communication chains may include a transmitter communication chain, a receiver communication chain, and/or a transceiver communication chain that may be used to implement a transmit port and/or a receiver port.

A WUS, such as an LP-WUS, may provide a UE with an indication of when to wake up and/or activate an MR, and when to extend a sleep duration. In some cases, the WUS may lack information that indicates whether a pending scheduling request may be associated with a single layer transmission that uses a single communication chain and/or a single port at the UE, or a multiple layer transmission that uses multiple communication chains and/or multiple ports at the UE. The lack of information may result in needless power consumption by the UE. For instance, a UE may include four communication chains and/or four ports to support a four-layer MIMO communication (e.g., a four-layer uplink MIMO communication and/or a four-layer downlink MIMO communication). Based at least in part on receiving a WUS, the UE may trigger the MR to activate, resulting in the MR powering all four communication chains and/or all four ports. However, a network node may have transmitted the WUS to schedule the UE with a single-layer communication. Accordingly, activating all four communication chains and/or all four ports in the MR at the UE may result in needless power consumption by the three communication chains and/or three ports that are unused by the UE to process the subsequent single-layer transmission. The needless consumption of power may drain the power resources of the UE, resulting in a shortened operating duration of the UE.

Various aspects relate generally to a communication configuration indication in a WUS, such as an LP-WUS. Some aspects more specifically relate to a UE adapting the activation of an MR based at least in part on the communication configuration indication in the WUS. In some aspects, a UE may transmit, to a network node, a WUS capability that indicates support for receiving a WUS that indicates a communication configuration that includes and/or indicates one or more of a first quantity of uplink (UL) or downlink (DL) MIMO) layers, a second quantity of transmit (TX) or receive (RX) ports, and/or a main radio physical downlink control channel (PDCCH) skip configuration. As one example, the communication configuration may be associated with a future communication that includes the first quantity of UL or DL MIMO layers and/or may use the second quantity of TX or RX ports. Alternatively, or additionally, the communication configuration may indicate to skip (or to not skip) PDCCH monitoring and/or PDCCH decoding via a main radio (e.g., at the UE). Based at least in part on transmitting the WUS capability, the UE may receive, from the network node, the WUS that indicates the communication configuration (e.g., the first quantity of UL or DL MIMO layers, the second quantity of TX or RX ports, and/or the main radio PDCCH skip configuration). The UE may communicate with the network node based at least in part on the communication configuration indicated by the WUS. For instance, the UE may activate a first quantity of TX or RX ports to transmit or receive the subsequent communication that includes the first quantity of UL or DL MIMO layers. Alternatively, or additionally, the UE may activate the second quantity of TX or RX ports to transmit or receive the future communication.

Particular aspects of the subject matter described in this disclosure can be implemented to realize one or more of the following potential advantages. In some examples, by receiving a WUS that indicates a communication configuration, such as an LP-WUS that indicates a first quantity of UL or DL MIMO layers and/or a second quantity of TX or RX ports, the described techniques can be used to enable a UE to reduce power consumption based at least in part on reducing a quantity (e.g., how many) of TX or RX ports at an MR that are transitioned to an active mode. For instance, a network node may indicate, in the WUS, a quantity of UL or DL MIMO layers that are being scheduled by the network node in a subsequent communication with the UE (e.g., an uplink communication or a downlink communication). The UE receiving the indication of the first quantity of UL or DL MIMO layers and/or the second quantity of TX or RX ports may direct an MR to wake up and/or activate the indicated quantity of ports and, consequently, an associated quantity of communication chains, which may be fewer TX or RX ports and/or communication chains than are included in the UE. Alternatively, or additionally, the UE may extend a sleep duration of the main radio based at least in part on the communication configuration indicating an enabled skip mode for a main radio PDCCH skip configuration. Activating fewer TX or RX ports at the UE and/or extending a sleep duration of a main radio at the UE may reduce power consumption by the UE, reduce drain on a power source at the UE (e.g., a battery), and extend an operating life of the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

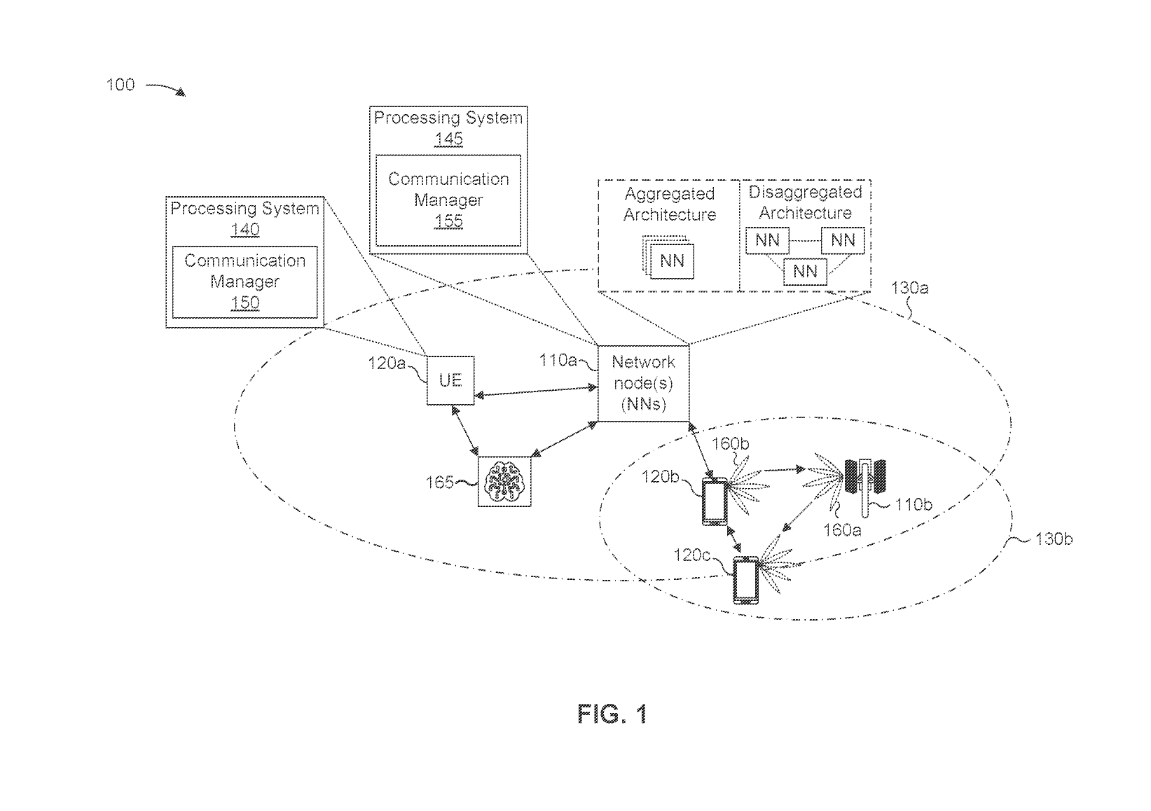

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

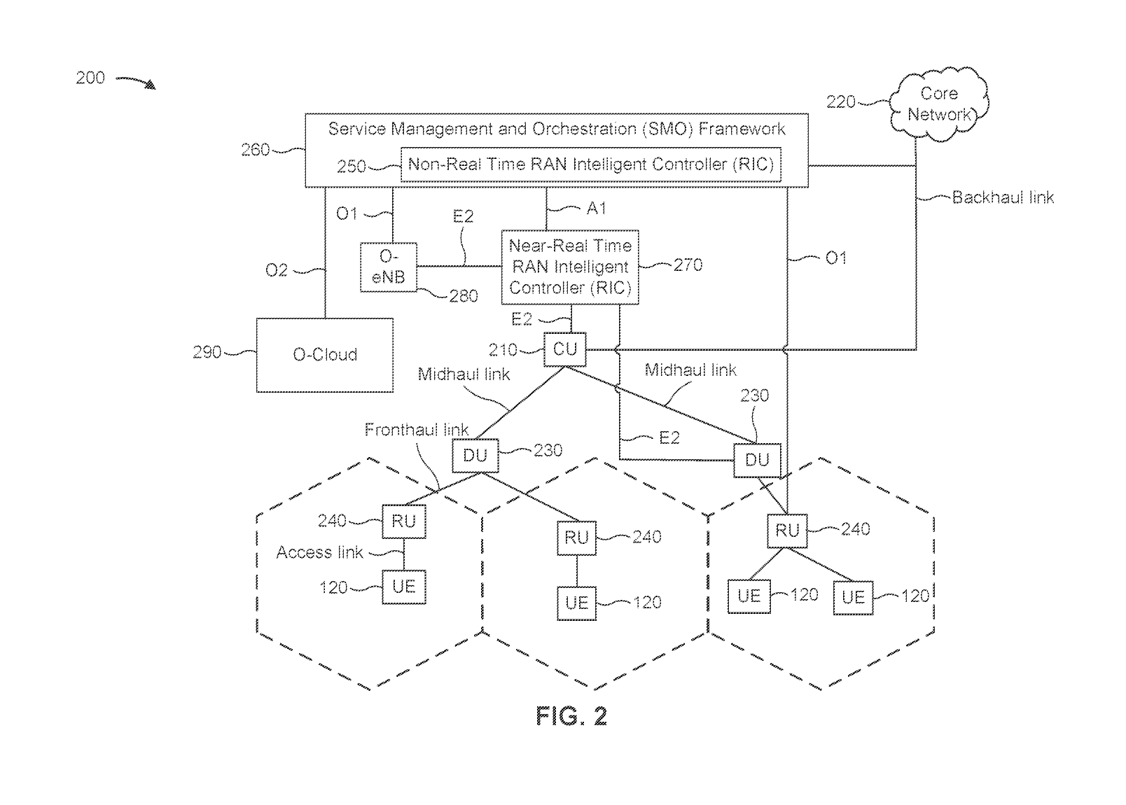

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE (e.g., a UE 120) may include a communication manager 150. As described in more detail elsewhere herein, the communication manager 150 may transmit, to a network node, a wakeup signal (WUS) capability that indicates support for receiving a WUS that indicates a communication configuration that comprises at least one of: a first quantity of UL or DL MIMO layers, a second quantity of TX or RX ports, or a main radio PDCCH skip configuration; receive, from the network node, the WUS that indicates the communication configuration; and communicate with the network node based at least in part on the communication configuration indicated by the WUS. Additionally, or alternatively, the communication manager 150 may perform one or more other operations described herein.

In some aspects, a network node (e.g., a network node 110) may include a communication manager 155. As described in more detail elsewhere herein, the communication manager 155 may receive, from a UE, a WUS capability that indicates support for receiving a WUS that indicates a communication configuration that comprises at least one of: a first quantity of UL or DL MIMO layers, a second quantity of TX or RX ports, or a main radio PDCCH skip configuration; transmit, to the UE, the WUS that indicates the communication configuration; and communicate with the UE based at least in part on the communication configuration indicated by the WUS. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

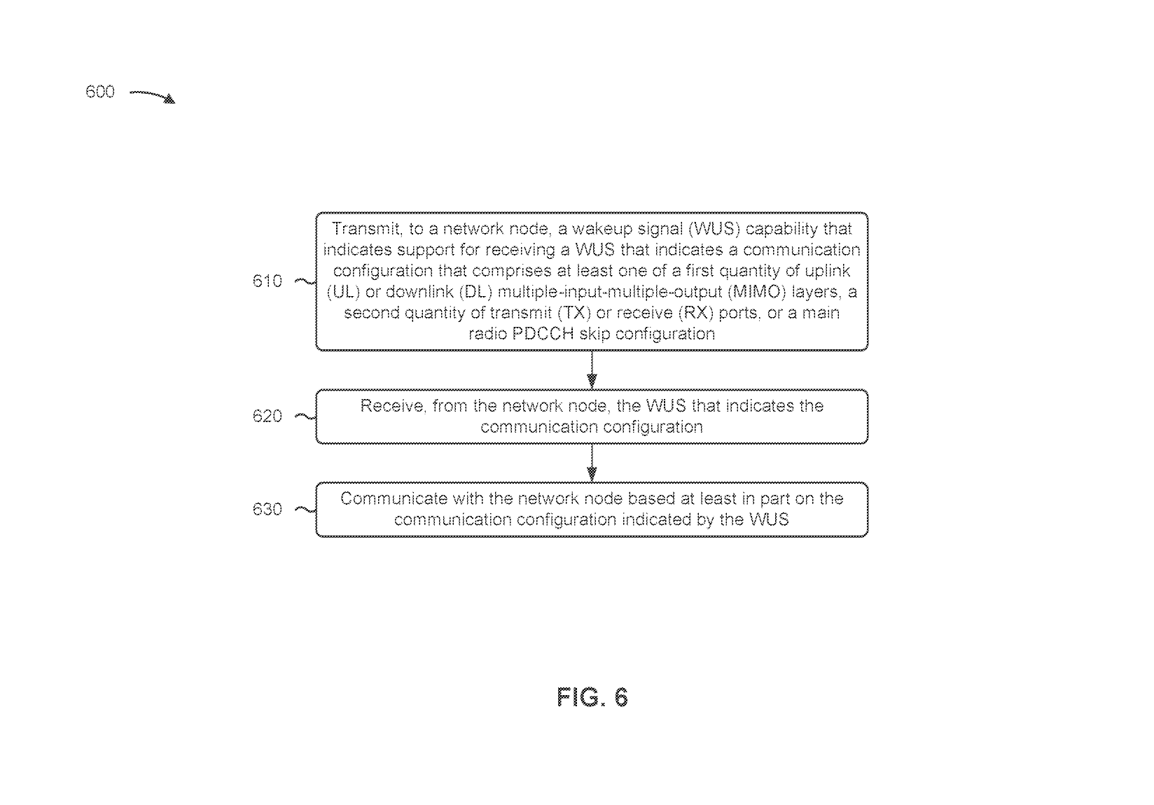

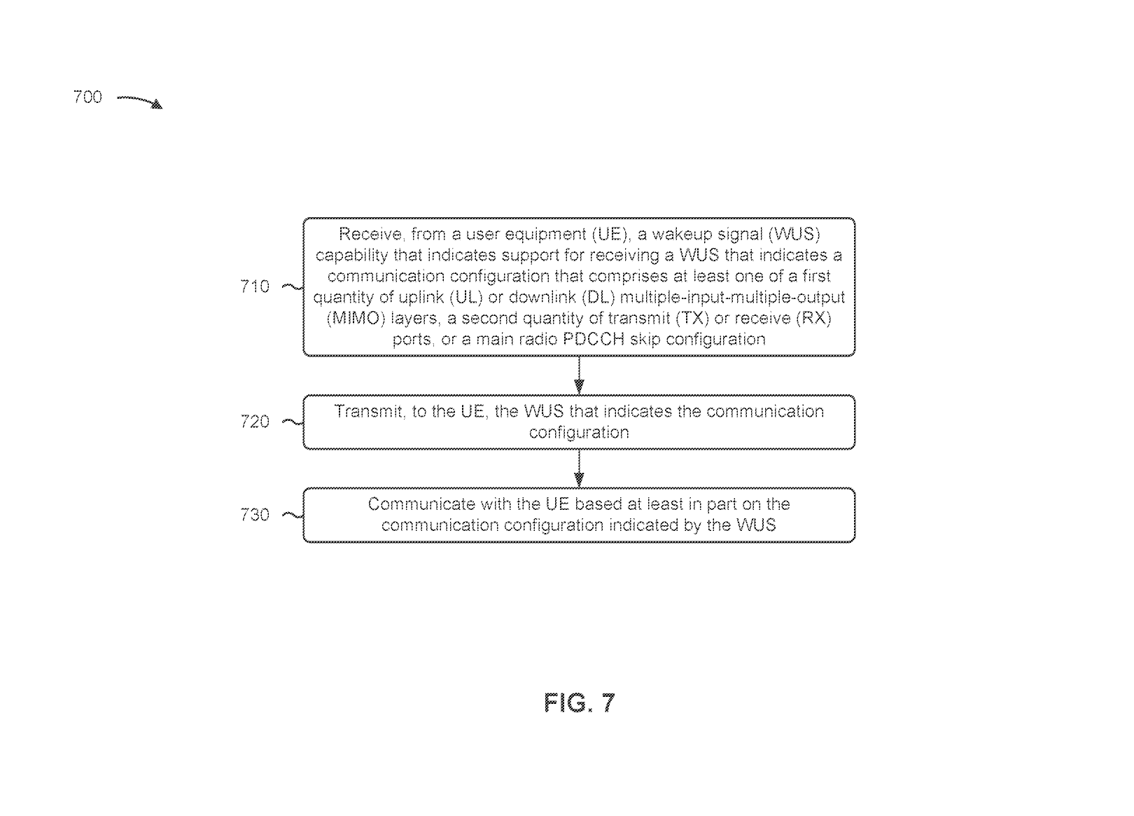

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a communication configuration indication in a WUS, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

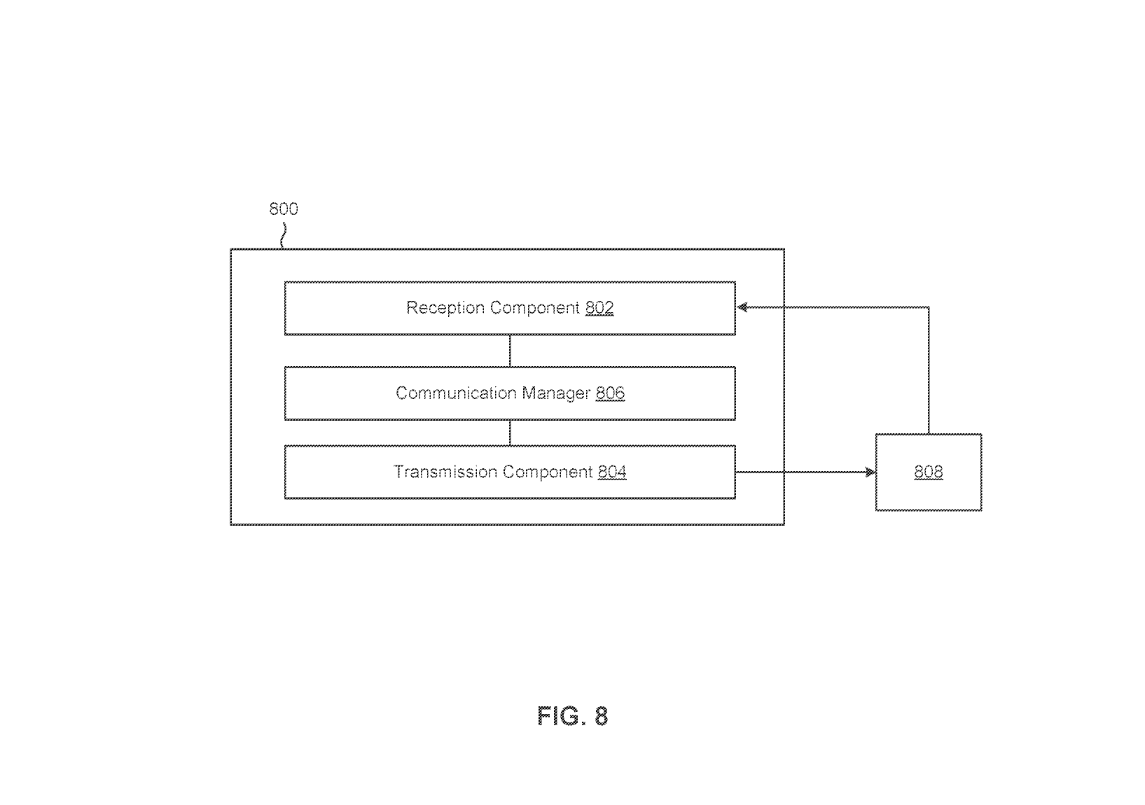

In some aspects, a UE (e.g., a UE 120) includes means for transmitting, to a network node, a WUS capability that indicates support for receiving a WUS that indicates a communication configuration that comprises at least one of: a first quantity of UL or DL MIMO layers, a second quantity of TX or RX ports, or a main radio PDCCH skip configuration; means for receiving, from the network node, the WUS that indicates the communication configuration; and/or means for communicating with the network node based at least in part on the communication configuration indicated by the WUS. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

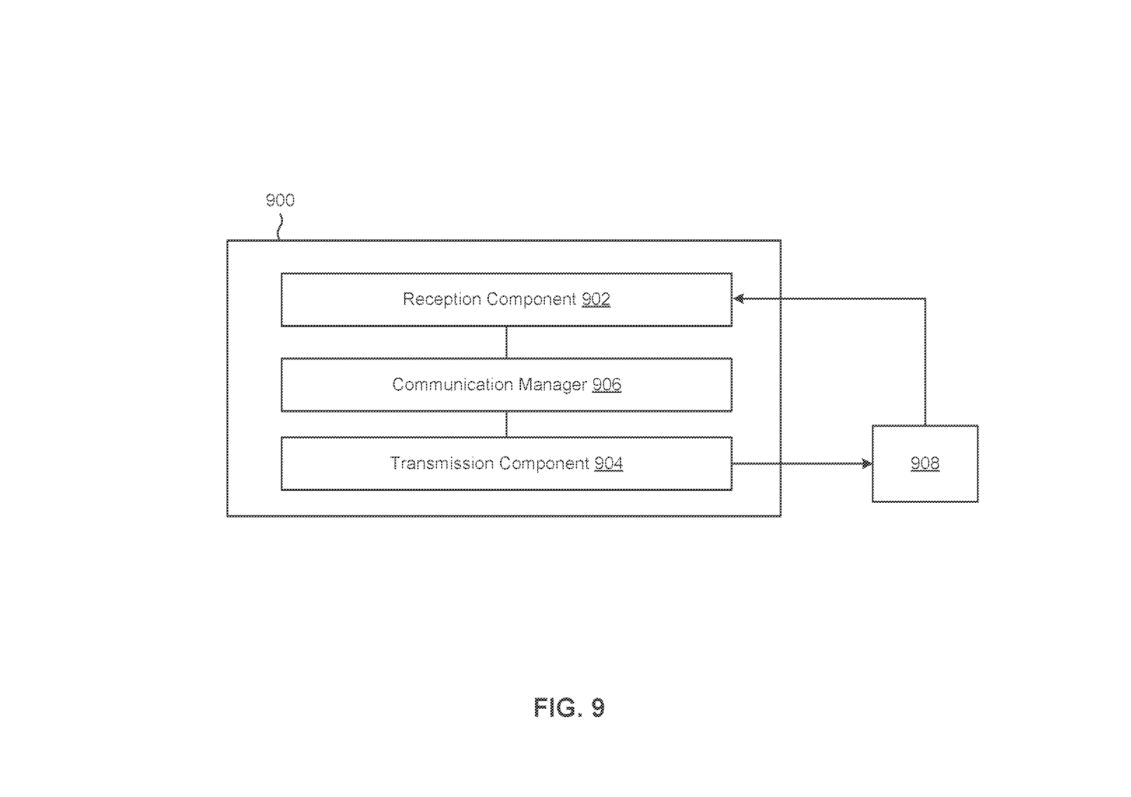

In some aspects, a network node (e.g., a network node 110) includes means for receiving, from a UE, a WUS capability that indicates support for receiving a WUS that indicates a communication configuration that comprises at least one of: a first quantity of UL or DL MIMO layers, a second quantity of TX or RX ports, or a main radio PDCCH skip configuration; means for transmitting, to the UE, the WUS that indicates the communication configuration; and/or means for communicating with the UE based at least in part on the communication configuration indicated by the WUS. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

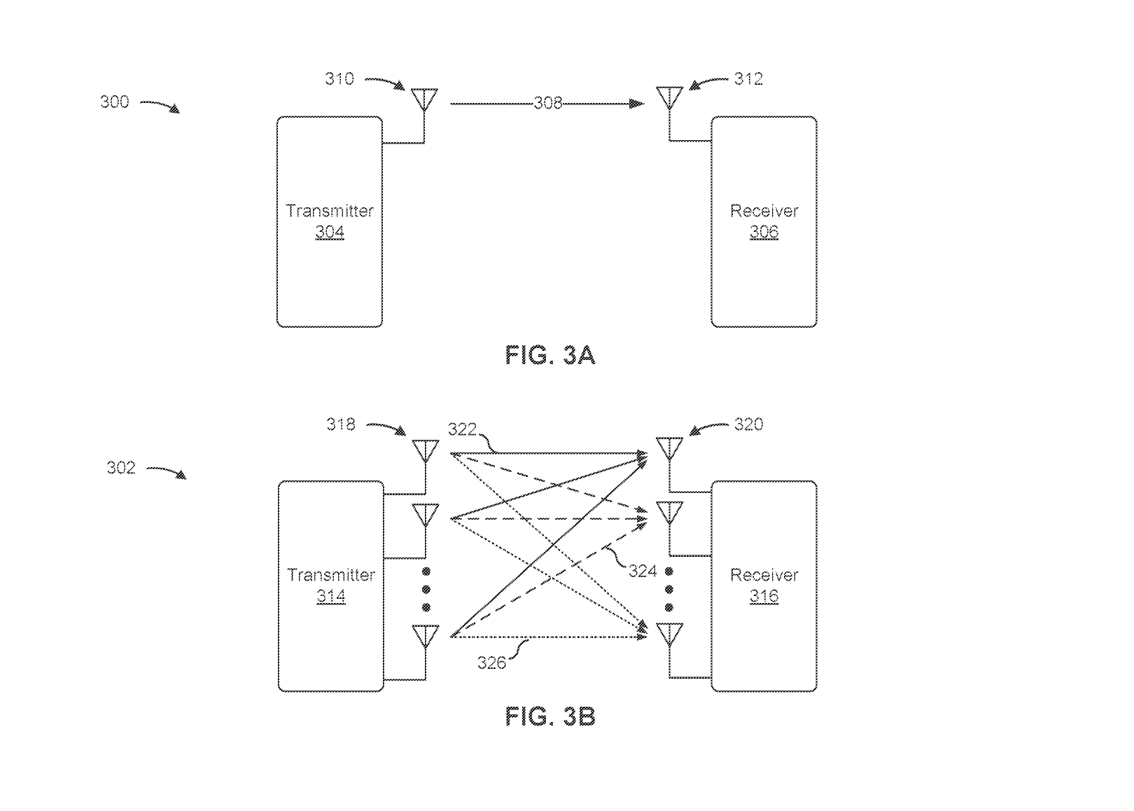

FIGS. 3A and 3B are diagrams illustrating a first example 300 and a second example 302 of a single-input-single-output (SISO) system and a MIMO system, respectively, in accordance with the present disclosure.

SISO systems and MIMO systems are two approaches to wireless communications. The use of a SISO system versus a MIMO system may depend on a variety of operating factors, such as requested data rates, data transfer latency operating conditions, implementation costs, and/or network access demand. A SISO system may provide a cost-effective solution for areas that have low network access demand, while a MIMO system may provide higher data throughput and/or lower data transfer latencies relative to a SISO system.

The first example 300 shown by FIG. 3A is an example SISO system that includes a transmitter device 304 (e.g., a network node 110 and/or a UE 120) that wirelessly communicates with a receiver device 306 (e.g., a network node 110 and/or a UE 120) based at least in part on transmitting a wireless signal 308. In the SISO system, the transmitter device 304 includes a first (single) antenna 310 that is used to transmit the wireless signal 308, and the receiver device includes a second (single) antenna 312 to receive the wireless signal 308. In the SISO system, the transmitter device 304 may communicate a single data stream to the receiver device 306 via the wireless signal.

The second example 302 shown by FIG. 3B is an example MIMO system that includes a transmitter device 314 (e.g., a network node 110 and/or a UE 120) and a receiver device 316 (e.g., a network node 110 and/or a UE 120). In the MIMO system, the transmitter device 314 and the receiver device 316 wirelessly communicate with one another based at least in part on multiple antennas and/or multiple communication chains. To illustrate, the transmitter device 314 may include M antennas as shown by reference number 318, and the receiver device 316 may include N antennas as shown by reference number 320, where M and N are integers that may be equal or different from one another (e.g., M = N, M > N, and/or M < N). For clarity, the second example 302 shows a transmitter in communication with a single receiver, but in other examples, the transmitter may serve and/or communicate with multiple receivers using the same antennas.

In some aspects, the transmitter device 314 may transmit multiple data streams via the M antennas based at least in part on using signal diversity, such as spatial diversity and/or polarization diversity. Alternatively, or additionally, the transmitter device 314 may transmit each data stream using a respective communication chain (e.g., a respective transmitter chain and/or a respective transceiver chain) and/or a respective port. Typically, the number of data streams transmitted by a transmitter device is fewer than a number of antennas. That is, the mapping of the number of data streams to the number of antennas is not 1:1. Rather, each stream may be mapped with a unique set of weighs to all of the available antenna such that all of the available antennas are used to transmit the multiple data streams. To illustrate, the transmitter device 314 may transmit a first data stream 322 (shown with a solid line) using all of the M antenna, a first set of precoding weights, and a first communication chain. That is, each antenna of the M antenna may transmit a respective signal that carries the first data stream, and the respective signal may be precoded using a particular weight in the first set of precoding weights. The first data stream may be processed by the first communication chain. Alternatively, or additionally, the transmitter device 314 may transmit a second data stream 324 (shown with a dashed line) using all of the M antenna, a second set of precoding weights, and a second communication. In a similar manner, the transmitter device may transmit a third data stream 326 (shown with a dotted line) using all of the M antenna, a third set of precoding weights, and a third communication chain. Other examples may include the transmitter device 314 transmitting each data stream using a respective subset of antennas of the M antennas.

In a similar manner, the receiver 316 may receive the first data stream 322 using all of the N antennas shown by reference number 320 and a first communication chain (e.g., a receiver chain and/or a transceiver chain). The first data stream may be processed by the first communication chain. Alternatively, or additionally, the receiver 316 may receive the second data stream 324 using all of the N antennas and a second communication chain and/or the third data stream 326 using all of the N antennas and a third communication chain. The second communication chain may process the second data stream, and/or the third communication chain may process the third data stream.

The demand for services provided by a wireless network continues to increase as more and more devices access the wireless network. A MIMO system may, in some cases, meet the demand based at least in part on the ability to simultaneously and/or contemporaneously transmit multiple data streams. To illustrate, and as described above, the use of multiple antennas in a MIMO system allow a transmitter device to simultaneously and/or contemporaneously transmit the multiple data streams using different paths (e.g., different spatial paths and/or different polarization paths), resulting in increased data throughput based at least in part on transmitting multiple data streams using diverse signals.

As indicated above, FIGS. 3A and 3B are provided as examples. Other examples may differ from what is described with regard to FIGS. 3A and 3B.

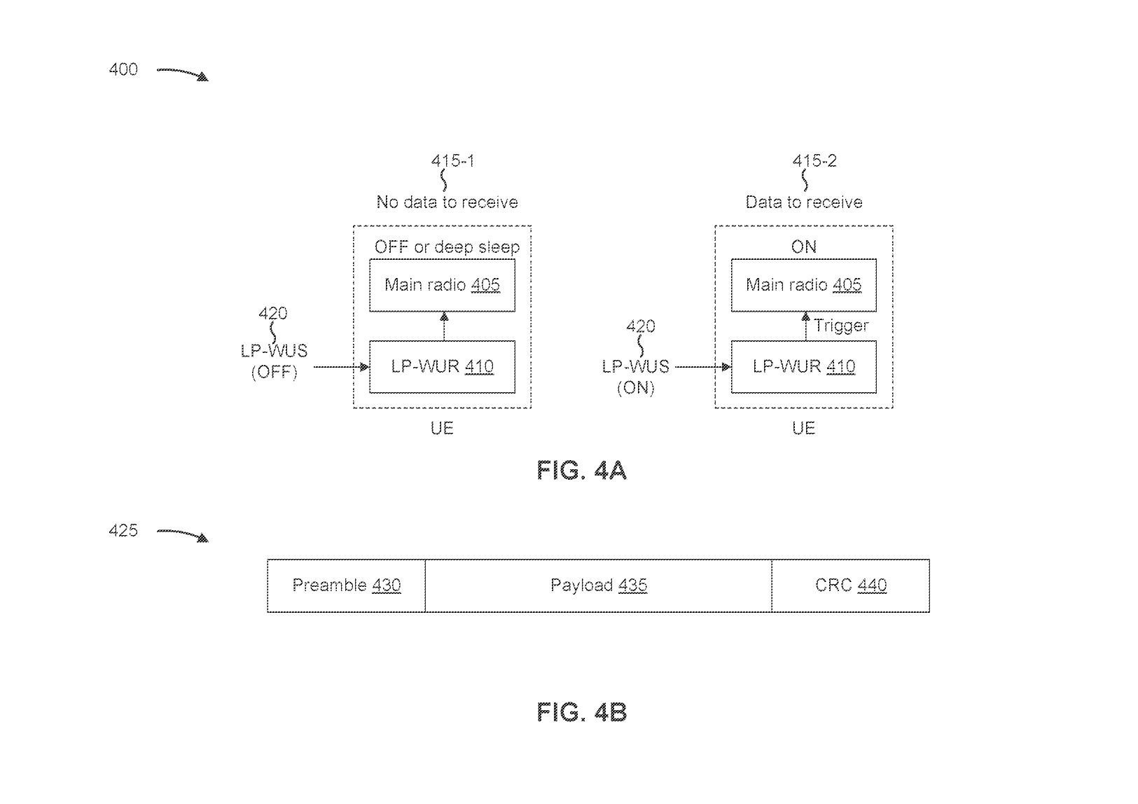

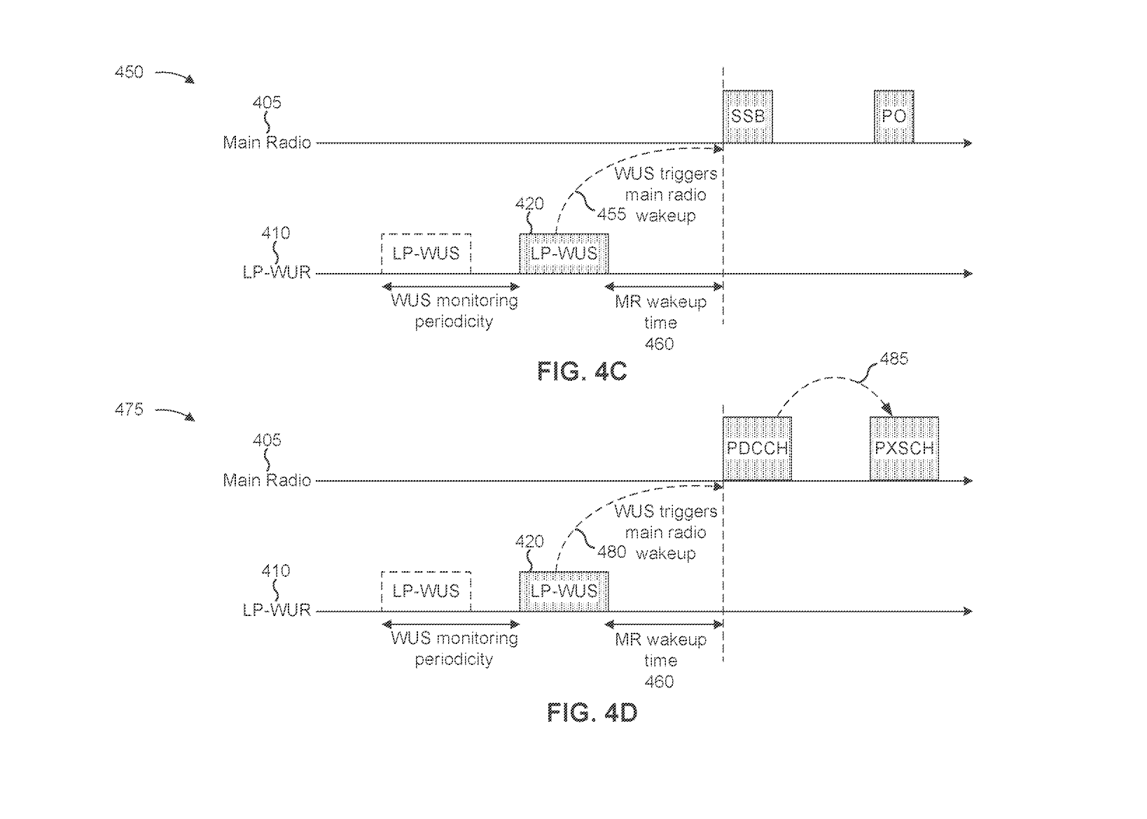

FIGS. 4A, 4B, 4C, and 4D are diagrams illustrating, respectively, a first example 400 of an LP-WUR, a second example 425 of an LP-WUS, a third example 450 of a first LP-WUS procedure, and a fourth example 475 of a second LP-WUS procedure, in accordance with the present disclosure. As shown in FIG. 4A, a UE (such as UE 120) may be equipped with a communication system that includes a main radio (illustrated as “MR”) 405 and an LP-WUR 410 to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 4A, the UE may be equipped with the LP-WUR 410, which may be considered a companion receiver that can be used with a main radio 405 to reduce power consumption and latency.

For example, in some aspects, the UE may generally use the main radio 405 to transmit and/or receive user data, and the main radio 405 may be turned off or operated in a deep sleep state unless there is user data to transmit and/or receive. Furthermore, the LP-WUR 410 may serve as a simple wakeup receiver for the main radio 405, and the LP-WUR 410 may be active and monitoring for an LP-WUS while the main radio 405 is off or in the deep sleep state. For example, reference number 415-1 depicts a first state associated with the main radio 405 and the LP-WUR 410 where there is no user data to be provided to the main radio 405. In such cases, the main radio 405 may be off or operated in the deep sleep state unless there is user data to transmit, and the LP-WUR 410 may monitor for an LP-WUS (for example, continuously, or periodically in monitoring occasions that are separated in time). Furthermore, reference number 415-2 depicts a second state associated with the main radio 405 and the LP-WUR 410 where there is user data for the main radio 405. In such cases, the LP-WUR 410 may receive an LP-WUS 420 (such as from a network node 110) and may provide a trigger to wake or otherwise activate the main radio 405 based on detecting the LP-WUS 420. Accordingly, the main radio 405 may then transmit and/or receive user data.

In general, the LP-WUR 410 may consume very little power (for example a target power consumption less than 100 microwatts (µW) in the active state), which may be achieved using simple modulation schemes (for example, on-off keying (OOK)), a narrow bandwidth (for example, less than 5 MHz), and/or other suitable techniques. In this way, the LP-WUR 410 can be used to reduce the time that the main radio 405 spends in an on state and/or may avoid unnecessarily waking the main radio 405 from the off or deep sleep state when there is no user data to transmit or receive, which tends to be costly from a power consumption perspective. Furthermore, because the LP-WUR 410 has a very low power consumption, the LP-WUR 410 can be used to frequently or continuously perform LP-WUS monitoring, which may improve latency because the main radio 405 can be woken up when there is user data that the main radio 405 needs to receive. For example, the LP-WUR 410 may not suffer from the latency versus power efficiency tradeoff associated with duty cycling schemes, such as DRX. Furthermore, in addition to performing LP-WUS monitoring, which may be used for paging reception, the LP-WUR 410 may monitor a low power synchronization signal (LP-SS) for time and frequency tracking and radio resource management (RRM) measurement. In this way, by monitoring the LP-SS, serving cell and/or neighbor cell monitoring can be offloaded from the main radio 405 to the LP-WUR 410 to reduce how often the main radio 405 is woken up, which can further reduce power consumption.

In some aspects, the LP-WUR 410 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 405.

In some aspects, the LP-WUR 410 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

The second example 425 shown by FIG. 4B is an example LP-WUS that may be transmitted by a network node 110 and/or received by a UE 120 as described herein. In some aspects, the network node 110 may transmit the LP-WUS shown by the second example 425 in one or more air interface resources of a resource pool that is dedicated to a LP-WUS (e.g., an RRC configured resource pool that is dedicated to a LP-WUS). As one example, the resource pool may be based at least in part on a paging search space. Alternatively, or additionally, the UE 120 may receive the LP-WUS using an LP-WUR (e.g., the LP-WUR 410) that consumes less power relative to a main radio (e.g., the main radio 405). For instance, a network node may modulate an LP-WUS (e.g., the LP-WUS 420) using a simplified modulation scheme (e.g., relative to OFDM), such as binary phase shift keying (BPSK) and/or amplitude shift keying (ASK), that enables a UE to implement and/or use an LP-WUR (e.g., the LP-WUR 410) that consumes less power relative to the main radio. One example ASK modulation scheme is OOK.

An LP-WUS may be partitioned into multiple sections and/or fields, and each section and/or field may carry different information. For instance, the LP-WUS shown by the second example 425 includes a preamble field 430, a payload field 435, and a cyclic redundancy check (CRC) field 440. The preamble field 430 may be configured with a fixed pattern and/or a pre-configured pattern of data (e.g., a fixed pattern of bits and/or a pre-configured pattern of bits), such as “10101010” or “11001100.” The inclusion of the preamble field 430 in the LP-WUS may enable a receiving device (e.g., a UE 120) to identify a presence of an LP-WUS and/or to synchronize to an incoming bit stream included in the LP-WUS, such as the payload field 435 and/or the CRC field 440. The payload field 435 may include one or more sub-fields, and each sub-field may be configured to carry respective information. For instance, the payload field 435 may include an identifier field that indicates an intended recipient of the LP-WUS. The CRC field 440 may enable a receiving device to detect whether the received data includes errors or not.

The third example 450 shown by FIG. 4C is a first example LP-WUS procedure that uses the LP-WUR 410. In some aspects, the first example LP-WUS procedure is associated with a UE operating in an idle mode or an inactive mode (e.g., an RRC idle mode or an RRC inactive mode). In the first application, the LP-WUR 410 monitors for the LP-WUS 420. Based at least in part on the UE operating in the idle mode and/or the inactive mode, receipt of the LP-WUS may indicate to monitor a paging occasion. In such a scenario, the LP-WUS may be used to reduce unnecessary paging reception performed by the main radio 405 and, consequently, conserve power. For example, as shown in FIG. 4C, the LP-WUR 410 may be configured to monitor for an LP-WUS 420 (while the main radio 405 is off or in a deep sleep state) according to a WUS monitoring periodicity. That is, the LP-WUR 410 may monitor for the LP-WUS 420 in periodic LP-WUS monitoring occasions that are spaced in time according to the WUS monitoring periodicity. Alternatively, although not explicitly shown in FIG. 4C, the LP-WUR 410 may be configured to continuously monitor for the LP-WUS 420. In general, a network node may transmit an LP-WUS 420 to a UE only in cases where there is a paging message that needs to be sent to the UE while the UE is in the idle mode or the inactive mode. In such cases, the LP-WUR 410 may receive and detect the LP-WUS 420, and, as shown by reference number 455, may trigger the LP-WUR 410 to wake up the main radio 405. In some aspects, the LP-WUS 420 may be a sequence-based WUS, which may include a predefined set of sequences (implemented, for example, using OOK modulation and/or phase modulation).

As shown by reference number 460, the main radio 405 may wake up after a main radio wakeup time, and may then start to monitor one or more synchronization signal block (SSB) transmissions to obtain synchronization with the network node before monitoring and receiving the paging message in a subsequent PO. In cases where the LP-WUR 410 does not detect the LP-WUS 420, the main radio 405 may remain in the deep sleep state to save power. Example wakeup times may include 12 milliseconds (msec) for a transition out of a light sleep mode and 15 msec for a transition out of a deep sleep mode. Example power consumption by the main radio 405 may include 62 milliamps (mA) while processing a PDCCH with a 20 MHz bandwidth and 2 communication layers, 145 mA for a PUSCH transmission that has a 20 MHz bandwidth, and 1.4 mA while operating in a deep sleep mode.

The fourth example 475 shown by FIG. 4D is a second application of the LP-WUR 410 that is associated with a UE operating in a connected mode (e.g., an RRC connected mode). In a similar manner as the first application described with regard to FIG. 4C, the LP-WUR 410 monitors for the LP-WUS 420. Based at least in part on the UE operating in a connected mode, receipt of the LP-WUS 420 may indicate to monitor a control channel (e.g., a PDCCH) for scheduling information. The use of the LP-WUS 420 for a UE operating in a connected mode may reduce a number of times that the UE operates in an active mode of an associated discontinuous reception (DRX cycle), which can be used to reduce unnecessary reception performed by the main radio 405. For example, in a similar manner as described with regard to FIG. 4C, the LP-WUR 410 may be configured to monitor for the LP-WUS 420 (while the main radio 405 is off or in a deep sleep state) according to the WUS monitoring periodicity. A network node may transmit an LP-WUS 420 to a UE in scenarios where there is a (pending) control channel message for the UE. In such cases, the network node may transmit the LP-WUS 420, which may be received and detected by the LP-WUR 410. As shown by reference number 480, reception and detection of the LP-WUS 420 may trigger the LP-WUR 410 to wake up the main radio 405. As shown by FIG. 4D, the main radio 405 may wake up after the main radio wakeup time, and may then start to monitor one or more PDCCH monitoring occasions (PMOs). Otherwise, in cases where the LP-WUR 410 does not detect the LP-WUS 420, the main radio 405 may remain in the deep sleep state to save power. In some aspects, the UE may receive scheduling information in PDCCH that occurs during a PMO, and the PDCCH may include scheduling information for a PDSCH transmission as shown by reference number 485.

A WUS, such as an LP-WUS, may provide a UE with an indication of when to wake up and/or activate an MR, and when to extend a sleep duration. In some cases, the WUS may lack information that indicates whether a pending scheduling request may be associated with a single layer transmission that uses a single communication chain and/or a single port at the UE, or a multiple layer transmission that uses multiple communication chains and/or multiple ports at the UE. The lack of information may result in needless power consumption by the UE. For instance, a UE may include four communication chains and/or four ports to support a four-layer MIMO communication (e.g., a four-layer uplink MIMO communication and/or a four-layer downlink MIMO communication). Based at least in part on receiving a WUS, the UE may trigger the MR to activate, resulting in the MR powering all four communication chains and/or all four ports. However, a network node may have transmitted the WUS to schedule the UE with a single-layer communication. Accordingly, activating all four communication chains and/or all four ports in the MR at the UE may result in needless power consumption by the three communication chains and/or three ports that are unused by the UE to process the subsequent single-layer transmission. The needless consumption of power may drain the power resources of the UE, resulting in a shortened operating duration of the UE.

Various aspects relate generally to a communication configuration indication in a WUS, such as an LP-WUS. Some aspects more specifically relate to a UE adapting the activation of an MR based at least in part on the communication configuration indication in the WUS. In some aspects, a UE may transmit, to a network node, a WUS capability that indicates support for receiving a WUS that indicates a communication configuration that includes and/or indicates one or more of a first quantity of UL or DL MIMO) layers, a second quantity of TX or RX ports, and/or a main radio PDCCH skip configuration. As one example, the communication configuration may be associated with a future communication that includes the first quantity of UL or DL MIMO layers and/or may use the second quantity of TX or RX ports. Alternatively, or additionally, the communication configuration may indicate to skip (or to not skip) PDCCH monitoring and/or PDCCH decoding via a main radio (e.g., at the UE). Based at least in part on transmitting the WUS capability, the UE may receive, from the network node, the WUS that indicates the communication configuration (e.g., the first quantity of UL or DL MIMO layers, the second quantity of TX or RX ports, and/or the main radio PDCCH skip configuration). The UE may communicate with the network node based at least in part on the communication configuration indicated by the WUS. For instance, the UE may activate a first quantity of TX or RX ports to transmit or receive a future communication that includes the first quantity of UL or DL MIMO layers. Alternatively, or additionally, the UE may activate the second quantity of TX or RX ports to transmit or receive the future communication.

Particular aspects of the subject matter described in this disclosure can be implemented to realize one or more of the following potential advantages. In some examples, by receiving a WUS that indicates a communication configuration, such as an LP-WUS that indicates a first quantity of UL or DL MIMO layers and/or a second quantity of TX or RX ports, the described techniques can be used to enable a UE to reduce power consumption based at least in part on reducing a quantity (e.g., how many) of TX or RX ports at an MR that are transitioned to an active mode and/or extending a sleep duration. For instance, a network node may indicate, in the WUS, a quantity of UL or DL MIMO layers that are being scheduled by the network node in a subsequent communication with the UE (e.g., an uplink communication or a downlink communication). The UE receiving the indication of the first quantity of UL or DL MIMO layers and/or the second quantity of TX or RX ports may direct an MR to wake up and/or activate the indicated quantity of ports and, consequently, an associated quantity of communication chains, which may be fewer TX or RX ports and/or communication chains than are included in the UE. Alternatively, or additionally, the UE may extend a sleep duration of the main radio based at least in part on the communication configuration indicating an enabled skip mode for a main radio PDCCH skip configuration. Activating fewer TX or RX ports at the UE and/or extending a sleep duration of a main radio at the UE may reduce power consumption by the UE, reduce drain on a power source at the UE (e.g., a battery), and/or extend an operating life of the UE.

As indicated above, FIGS. 4A, 4B, 4C, and 4D are provided as examples. Other examples may differ from what is described with regard to FIGS. 4A, 4B, 4C, and 4D.

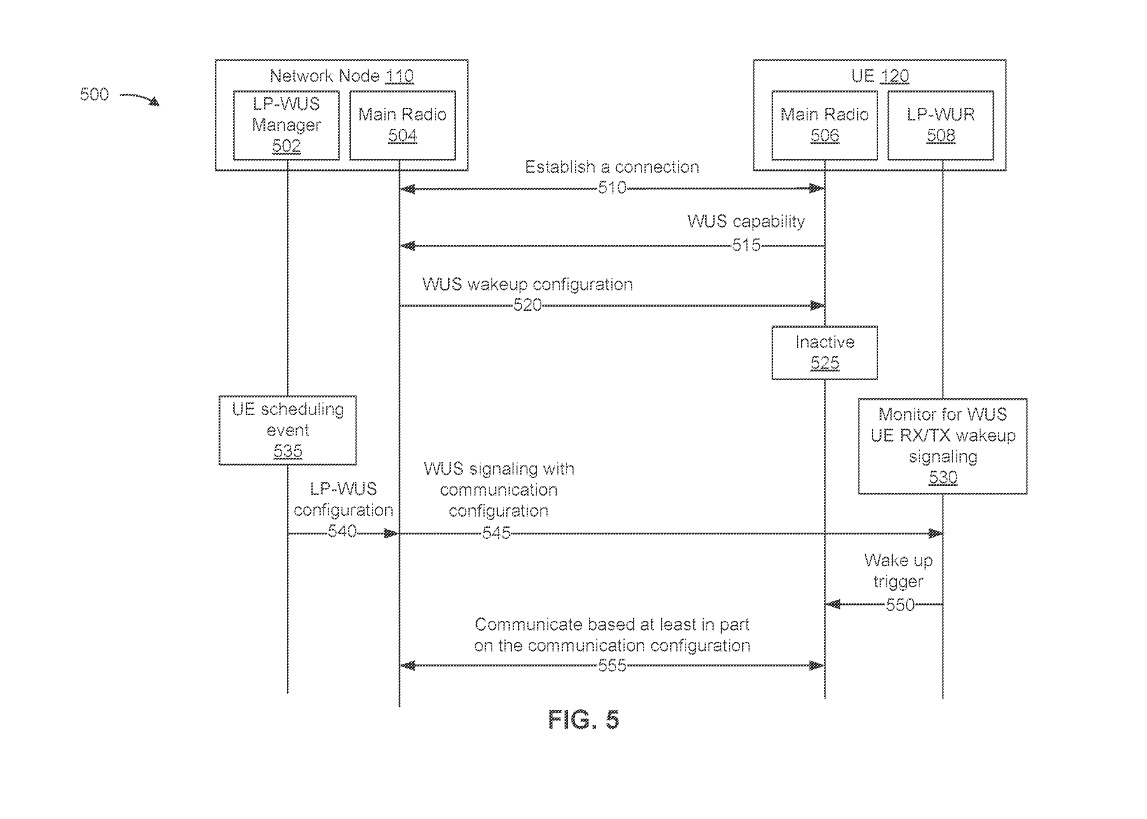

FIG. 5 is a diagram illustrating an example 500 of a wireless communication process between a network node (e.g., a network node 110) and a UE (e.g., a UE 120), in accordance with the present disclosure. As shown by FIG. 5, the network node 110 may include an LP-WUS manager 502 and a main radio 504, and the UE 120 may include a main radio 506 (e.g., a main radio 405) and an LP-WUR 508 (e.g., a LP-WUR 410). In some aspects, the LP-WUS manager 502 is implemented using any combination of software, hardware, and/or firmware. For instance, the LP-WUS manager 502 may be a software module that manages and/or configures the main radio 504 to transmit an LP-WUS, such as a software module that is included in a communication manager 155 and provides LP-WUS capabilities to the network node 110.

As shown by reference number 510, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE 120 being tolerant of communication delays, and the network node 110 may transmit an activation of the configuration via Layer 2 signaling and/or Layer 1 signaling at a second point in time associated with the UE being less tolerant to communication delays. As shown by FIG. 5, the network node 110 and the UE 120 may establish the connection based at least in part on the network node using the main radio 504 and the UE using the main radio 506.

As shown by reference number 515, the UE 120 may transmit, and the network node 110 may receive, a WUS capability that indicates support for receiving a WUS that indicates and/or includes a communication configuration that indicates a first quantity of UL or DL MIMO layers and/or a second quantity of TX or RX ports. That is, the WUS capability may indicate that the UE 120 supports receiving a WUS that indicates a transmission configuration that is associated with a future transmission (e.g., a future downlink transmission and/or a future uplink transmission) and/or a transmission configuration that may affect how the UE 120 activates a main radio (e.g., the main radio 506). For instance, the WUS may indicate a quantity (e.g., how many) of UL MIMO layers and/or DL MIMO layers that are scheduled for the future transmission, thus providing the UE 120 with an indication of how many TX ports and/or RX ports to activate at the main radio 506. Each TX port and/or each RX port may be associated with one or more respective communication chains (e.g., one or more receiver chains, one or more transmitter chains, and/or one or more transceiver chains).

Alternatively, or additionally, the WUS capability may indicate a quantity of TX ports and/or RX ports that the UE 120 may selectively activate at the main radio 506. In some aspects, the WUS capability may indicate a time offset and/or a duration that is associated with the UE 120 enabling a TX and/or RX port at the main radio 506. That is, the time offset may be associated with transitioning at least part of a main radio (e.g., a port and/or a communication chain) from a sleep state to an active state. In some aspects, the time offset is a scalable time offset. To illustrate, the time offset may be associated with activating a single port (e.g., a single TX port and/or a single RX port) such that a first duration that is associated with activating two ports may be computed as twice the indicated time offset and/or that a second duration that is associated with activating X ports may be computed as X times the indicated time offset. Alternatively, or additionally, the WUS capability may indicate a main radio PDCCH skip capability of the UE 120, such as a capability to skip PDCCH monitoring via a main radio at the UE 120 and/or a capability to skip PDCCH decoding associated with the main radio at the UE 120.

For clarity, FIG. 5 illustrates the UE 120 transmitting the WUS capability in a separate transaction than establishing a connection with the network node 110. However, in some aspects, the UE 120 may transmit the WUS capability as part of establishing a connection with the network node 110. As shown by FIG. 5, the UE 120 may transmit the WUS capability using the main radio 506.

As shown by reference number 520, the network node 110 may transmit, and the UE 120 may receive, a WUS configuration that indicates an activation state of a WUS that indicates a communication configuration (e.g., a first quantity of uplink and/or downlink MIMO layers and/or a second quantity of TX and/or RX ports). For instance, the WUS configuration may indicate an enabled activation state that indicates that the network node 110 will transmit a WUS that indicates a communication configuration and/or a disabled activation state that indicates the network node 110 will not transmit a WUS that indicates a communication configuration. Alternatively, or additionally, the WUS configuration may indicate a time offset difference, such as a timing adjustment the network node 110 may use to transmit a WUS that indicates the communication configuration. The time offset difference may indicate an absolute value for a timing adjustment or a delta value (e.g., relative to a time offset indicated by the UE 120 in capability information). In some aspects, the WUS configuration may indicate an activation state of a WUS main radio PDCCH skip indication state. To illustrate, the network node 110 may indicate an enabled state for the WUS main radio PDCCH skip indicate state to indicate that a subsequent WUS may indicate a main radio PDCCH skip configuration, and may indicate a disabled state for the WUS main radio PDCCH skip indicate state to indicate that a subsequent WUS will not indicate a main radio PDCCH skip configuration.

As shown by reference number 525, the UE 120 may transition the main radio 506 to an inactive mode and/or a sleep mode. For example, the UE 120 may operate in a connected mode (e.g., RRC connected mode) in combination with a DRX cycle and, as at least part of operating in a DRX cycle, the UE 120 may transition an MR to a deep sleep mode. In transitioning the main radio 506 to an inactive mode, the UE 120 may reduce an amount of power supplied to the main radio 506, may disable one or more ports (e.g. TX and/or RX ports), and/or may disable one or more communication chains. Disabling a port and/or a communication chain may include configuring the port and/or the communication chain in an operating mode that reduces power consumption by the port and/or the communication chain. Disabling the port and/or the communication chain may make the port and/or the communication temporarily inoperable for transmitting and/or receiving signals.

As shown by reference number 530, the UE 120 may monitor for a WUS, such as by monitoring for an LP-WUS using the LP-WUR 508. As part of monitoring for a WUS, the UE may monitor for a presence of a preamble associated with the WUS and/or may monitor a transmission channel associated with the WUS. For instance, based at least in part on monitoring for an LP-WUS, the UE 120 may monitor one or more air interface resources of a dedicated resource pool (e.g., an RRC configured resource pool that is dedicated to an LP-WUS). Alternatively, or additionally, the UE 120 may monitor for the WUS using a WUS receiver that is different from a main radio at the UE, such as an LP-WUR that is configured to consume less power than the main radio.

As shown by reference number 535, the LP-WUS manager 502 may receive an indication of a UE scheduling event. For instance, a communication manager of the network node 110 (e.g., the communication manager 155) may receive an indication of a future communication (e.g., a user data communication) that is associated with the UE 120, such as a future downlink communication and/or a future uplink communication. The communication manager 155 may select UE scheduling information that configures the future communication, such as a quantity of MIMO layers associated with the communication layer, one or more air interface resources assigned to the future communication, and/or a beam configuration. The communication manager 155 may indicate the UE scheduling information to the LP-WUS manager 502, and the LP-WUS manager 502 may select a communication configuration to include in a WUS that is directed to the UE 120 (e.g., an LP-WUS that indicates a communication configuration).

As shown by reference number 540, the LP-WUS manager 502 may communicate a communication configuration to the main radio 504. For instance, the LP-WUS manager 502 may communicate the communication configuration to a portion of the communication manager 155 (e.g., using a communication mechanism that is internal to the communication manager 155) that manages transmissions, and the communication manager 155 may trigger the main radio 504 to transmit the WUS.

As shown by reference number 545, the network node 110 may transmit, and the UE 120 may receive, an WUS that indicates a communication configuration. In some aspects, the WUS may include a preamble field, a payload field, and/or a CRC field as described with regard to FIG. 4B. Alternatively, or additionally, the WUS may be an LP-WUS as described with regard to FIGS. 4A-4D. In some aspects, the network node may transmit the WUS in one or more air interface resources of a dedicated resource pool. In some aspects, the network node 110 may transmit the WUS based at least in part on a time offset difference and/or a timing adjustment that is based at least in part on a time offset associated with the UE 120 waking up a main radio. The timing adjustment and/or the time offset difference may allow the UE 120 time to receive a WUS and activate the TX ports and/or RX ports as indicated by the WUS in sufficient time to transmit and/or receive a subsequent communication.

The communication configuration may indicate a first quantity of UL and/or DL MIMO layers and/or a second quantity of TX and/or RX ports. To illustrate, the communication configuration may indicate, as first quantity of UL or DL MIMO layers, one or more downlink MIMO layers and/or one or more uplink MIMO layers. Alternatively, or additionally, the communication configuration may indicate, as the second quantity of TX or RX ports, one or more TX ports and/or one or more RX ports. In some aspects, the WUS may indicate that the communication configuration is a secondary cell (SC)-specific communication configuration, a secondary cell group (SCG)-specific communication configuration, and/or a dual connectivity-specific communication configuration (e.g., New Radio dual connectivity (NRDC)). As described above, the communication configuration may be associated with a future communication that the network node 110 has scheduled and/or is scheduling for the UE 120. Alternatively, or additionally, the communication configuration may indicate an enabled state, or a disabled state, for a main radio PDCCH skip configuration that may enable the UE 120 to extend a sleep duration of the main radio. To illustrate, the network node 110 may indicate, via the main radio PDCCH skip configuration, to skip PDCCH monitoring and/or PDCCH decoding based at least in part on a subsequent grant (e.g., an uplink grant and/or a downlink grant) being the same and/or having a same configuration as a previous grant. As another example, the network node 110 may indicate, via the main radio PDCCH skip configuration, to skip PDCCH monitoring and/or PDCCH decoding for a PDCCH that is associated with a retransmission (e.g., an uplink data retransmission and/or a downlink data retransmission) and/or a particular HARQ identifier.

In some aspects, the network node 110 may indicate the communication configuration using one or more fields included in a payload of the WUS, such as the payload field described with regard to FIG. 4B. For instance, the payload of the WUS may include a first field (e.g., a 1-bit field, a 2-bit field, and/or a 3-bit field) that indicates a quantity of ports to activate (TX and/or RX), a second field that indicates a quantity of MIMO layers (e.g., uplink and/or downlink), and/or a third field that indicates a main radio PDCCH skip configuration. The field(s) may be dedicated fields (e.g., dedicated to indicating a quantity of TX ports, dedicated to indicating a quantity of RX ports, and/or dedicated to indicating a quantity of MIMO layers) and/or may be reused fields. An example of a reused field may be a reserved field that is used to indicate any portion of the communication configuration as described above.

The network node 110 may transmit the WUS based at least in part on timing adjustments associated with UE capability information. For instance, the network node 110 may adjust the timing of transmitting the WUS based at least in part on a quantity of TX ports and/or RX ports that the WUS indicates to activate and a time offset capability of the UE 120. As described above, a time offset indicated by the UE 120 may be scalable such that the network node 110 uses a timing adjustment that is a scaled version of the time offset based at least in part on the quantity of TX ports and/or RX ports indicated by the WUS.

As shown by reference number 550, the UE 120 may trigger the main radio 506 to activate one or more TX and/or RX ports (and, consequently, one or more communication chains, such as one or more receiver chains, transmitter chains, and/or transceiver chains) based at least in part on receiving the WUS. To illustrate, the UE 120 may decode a first quantity of UL and/or DL MIMO layers indicated by the WUS and derive a quantity of TX ports and/or RX ports to enable and/or activate in the main radio 506. Alternatively, or additionally, the UE 120 may decode a second quantity of TX and/or RX ports indicated by the WUS. In some aspects, the UE 120 may trigger the main radio 506 to activate fewer TX ports and/or RX ports than are included in the main radio 506, resulting in the main radio 506 consuming less power relative to activating all TX ports and/or RX ports included in the main radio 506.As one example, based at least in part on the WUS indicating one MIMO layer and/or one port, the UE 120 may activate, wake up, and/or supply more power to one port (e.g., one TX port and/or one RX port) of the main radio 506, instead of all of the ports included in the main radio 506. In some aspects, the UE may extend a sleep duration of the main radio based at least in part on the communication configuration indicating an enabled skip mode for a main radio PDCCH skip configuration that indicates to skip monitoring a PDCCH and/or to skip decoding the PDCCH using the main radio.

By supplying power to fewer ports and, consequently fewer communication chains than are supported and/or included in the UE 120, the UE 120 may mitigate needless power consumption by unused hardware at the UE 120 and reduce power consumption by the UE 120, which may result in the UE 120 operating for a longer duration relative to a scenario that includes the UE 120 supplying power to all of the communication chains in the MR. As another example, based at least in part on the WUS indicating four MIMO layers and/or four ports, the UE 120 may activate, wake up, and/or supply more power to four ports that may be based at least in part on any combination of one or more receiver chains, one or more transceiver chains, and/or one or more transmitter chains. Activating a same quantity of ports as indicated by the WUS may enable the UE 120 to decode communications from (and/or transmit communications to) the network node 110 in a manner that mitigates needless power consumption. As yet another example, extending a sleep duration of a main radio may reduce power consumption by the main radio.

As shown by reference number 555, the network node 110 and the UE 120 may communicate with one another based at least in part on the communication configuration indicated by the WUS. As one example, the UE 120 may transmit an uplink communication using the activated ports of the main radio 506. As another example, the UE 120 may receive a downlink communication using the activated ports. In some aspects, the uplink communication and/or the downlink communication may be a MIMO communication that includes multiple MIMO layers, and the UE 120 may transmit and/or receive a respective MIMO layer using a respective port that is activated.

A WUS that indicates a communication configuration, such as an LP-WUS that indicates a first quantity of UL or DL MIMO layers and/or a second quantity of TX or RX ports, may enable a UE to reduce power consumption based at least in part on reducing a quantity (e.g., how many) of TX or RX ports at an MR that are transitioned to an active mode. For instance, a network node may indicate, in the WUS, a quantity of UL or DL MIMO layers that are being scheduled by the network node in a subsequent communication with the UE (e.g., an uplink communication or a downlink communication). The UE receiving the indication of the first quantity of UL or DL MIMO layers and/or the second quantity of TX or RX ports may direct an MR to wake up and/or activate the indicated quantity of ports and, consequently, an associated quantity of communication chains, which may be fewer TX or RX ports and/or communication chains than are included in the UE. Alternatively, or additionally, the UE may extend a sleep duration of the main radio based at least in part on the communication configuration indicating an enabled skip mode for a main radio PDCCH skip configuration. Activating fewer TX or RX ports at the UE and/or extending a sleep duration of a main radio at the UE may reduce power consumption by the UE, reduce drain on a power source at the UE (e.g., a battery), and extend an operating life of the UE.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with a communication configuration indication in a wakeup signal.

As shown in FIG. 6, in some aspects, process 600 may include transmitting, to a network node, a WUS capability that indicates support for receiving a WUS that indicates a communication configuration that includes at least one of: a first quantity of UL or DL MIMO layers, a second quantity of TX or RX ports, or a main radio PDCCH skip configuration (block 610). For example, the UE (e.g., using transmission component 804 and/or communication manager 806, depicted in FIG. 8) may transmit, to a network node, a WUS capability that indicates support for receiving a WUS that indicates a communication configuration that includes at least one of: a first quantity of UL or DL MIMO layers, a second quantity of TX or RX ports, or a main radio PDCCH skip configuration, as described above.

As further shown in FIG. 6, in some aspects, process 600 may include receiving, from the network node, the WUS that indicates the communication configuration (block 620). For example, the UE (e.g., using reception component 802 and/or communication manager 806, depicted in FIG. 8) may receive, from the network node, the WUS that indicates the communication configuration, as described above.

As further shown in FIG. 6, in some aspects, process 600 may include communicating with the network node based at least in part on the communication configuration indicated by the WUS (block 630). For example, the UE (e.g., using reception component 802, transmission component 804, and/or communication manager 806, depicted in FIG. 8) may communicate with the network node based at least in part on the communication configuration indicated by the WUS, as described above.

Process 600 may include additional aspects, such as any single aspect or any combination of aspects described below and/or in connection with one or more other processes described elsewhere herein.

In a first aspect, the communication configuration indicates, as the first quantity of UL or DL MIMO layers, at least one of a third quantity of downlink MIMO layers, or a fourth quantity of uplink MIMO layers.

In a second aspect, the communication configuration indicates, as the second quantity of TX or RX ports, at least one of a fifth quantity of TX ports, or a sixth quantity of RX ports.

In a third aspect, the communication configuration indicates an enabled state for the main radio PDCCH skip configuration, the enabled state indicating to skip at least one of main radio PDCCH monitoring, or main radio PDCCH decoding.

In a fourth aspect, the WUS capability indicates at least one of a seventh quantity of TX or RX ports that are supported by the UE, a time offset, or a main radio PDCCH skip capability.

In a fifth aspect, the time offset is scalable based at least in part on the communication configuration.

In a sixth aspect, process 600 includes receiving, from the network node, a WUS configuration that is associated with an activation state of the WUS indicating the communication configuration.

In a seventh aspect, the WUS configuration indicates at least one of the activation state, a time offset difference, or a WUS main radio PDCCH skip indication state.

In an eighth aspect, process 600 includes monitoring for the WUS using a WUS receiver that is different from a main radio at the UE, the WUS receiver configured to consume less power than the main radio.

In a ninth aspect, communicating with the network node based at least in part on the communication configuration indicated by the WUS includes activating any configuration of one or more TX ports or one or more RX ports that are associated with a main radio of the UE based at least in part on the communication configuration.

In a tenth aspect, the configuration includes at least one TX port of the one or more TX ports, and communicating with the network node includes transmitting an uplink communication using the at least one TX port

In an eleventh aspect, the configuration includes at least one RX port of the one or more RX ports, and communicating with the network node includes receiving downlink communication using the at least one RX port.

In a twelfth aspect, communicating with the network node includes communicating a MIMO communication using the configuration of the one or more TX ports or the one or more RX ports.

In a thirteenth aspect, the WUS indicates to activate at least one of a secondary-cell-specific communication configuration, a secondary-cell-group-specific communication configuration, or a dual-connectivity-specific communication configuration.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with a communication configuration indication in a wakeup signal.

As shown in FIG. 7, in some aspects, process 700 may include receiving, from a UE, a WUS capability that indicates support for receiving a WUS that indicates a communication configuration that includes at least one of: a first quantity of UL or DL MIMO layers, a second quantity of TX or RX ports, or a main radio PDCCH skip configuration (block 710). For example, the network node (e.g., using reception component 902 and/or communication manager 906, depicted in FIG. 9) may receive, from a UE, a WUS capability that indicates support for receiving a WUS that indicates a communication configuration that includes at least one of: a first quantity of UL or DL MIMO layers, a second quantity of TX or RX ports, or a main radio PDCCH skip configuration, as described above.

As further shown in FIG. 7, in some aspects, process 700 may include transmitting, to the UE, the WUS that indicates the communication configuration (block 720). For example, the network node (e.g., using transmission component 904 and/or communication manager 906, depicted in FIG. 9) may transmit, to the UE, the WUS that indicates the communication configuration, as described above.

As further shown in FIG. 7, in some aspects, process 700 may include communicating with the UE based at least in part on the communication configuration indicated by the WUS (block 730). For example, the network node (e.g., using reception component 902, transmission component 904, and/or communication manager 906, depicted in FIG. 9) may communicate with the UE based at least in part on the communication configuration indicated by the WUS, as described above.

Process 700 may include additional aspects, such as any single aspect or any combination of aspects described below and/or in connection with one or more other processes described elsewhere herein.

In a first aspect, the WUS is a low power WUS.

In a second aspect, the communication configuration indicates, as the first quantity of UL or DL MIMO layers, at least one of a third quantity of UL MIMO layers, or a fourth quantity of DL MIMO layers.

In a third aspect, the communication configuration indicates, as the second quantity of TX or RX ports, at least one of a fourth quantity of TX ports, or a fifth quantity of RX ports.

In a fourth aspect, the communication configuration indicates an enabled state for the main radio PDCCH skip configuration, the enabled state indicating to skip at least one of main radio PDCCH monitoring, or main radio PDCCH decoding.

In a fifth aspect, the WUS capability indicates at least one of a seventh quantity of TX or RX ports that are supported by the UE, a time offset, or a main radio PDCCH skip capability.

In a sixth aspect, the time offset is scalable based at least in part on the communication configuration.

In a seventh aspect, process 700 includes transmitting, to the UE, a WUS configuration that indicates an activation state of the WUS indicating the communication configuration.

In an eighth aspect, the WUS configuration indicates at least one of the activation state, a time offset difference, or a WUS main radio PDCCH skip indication state.

In a ninth aspect, communicating with the UE includes receiving, from the UE, an uplink communication that is based at least in part on the communication configuration.

In a tenth aspect, communicating with the UE includes transmitting, to the UE, a downlink communication that is based at least in part on the communication configuration.

In an eleventh aspect, communicating with the UE includes communicating a MIMO communication that is based at least in part on the communication configuration.

In a twelfth aspect, the MIMO communication includes at least one of an uplink MIMO communication, or a downlink MIMO communication.

In a thirteenth aspect, the WUS indicates to activate at least one of a secondary-cell-specific communication configuration, a secondary-cell-group-specific communication configuration, or a dual-connectivity-specific communication configuration.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit, to a network node, a WUS capability that indicates support for receiving a WUS that indicates a communication configuration that includes at least one of a first quantity of UL or DL MIMO layers, a second quantity of TX or RX ports, or a main radio PDCCH skip configuration. The reception component 802 may receive, from the network node, the WUS that indicates the communication configuration. The reception component 802 and/or the transmission component 804 may communicate with the network node based at least in part on the communication configuration indicated by the WUS.

The reception component 802 may receive, from the network node, a WUS configuration that is associated with an activation state of the WUS indicating the communication configuration. In some aspects, the communication manager 806 may monitor for the WUS using a WUS receiver that is different from a main radio at the UE, the WUS receiver configured to consume less power than the main radio.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a UE, a WUS capability that indicates support for receiving a WUS that indicates a communication configuration that includes at least one of a first quantity of UL or DL MIMO layers, a second quantity of TX or RX ports, or a main radio PDCCH skip configuration. The transmission component 904 may transmit, to the UE, the WUS that indicates the communication configuration. The reception component 902 and/or the transmission component 904 may communicate with the UE based at least in part on the communication configuration indicated by the WUS. In some aspects, the transmission component 904 may transmit, to the UE, a WUS configuration that indicates an activation state of the WUS indicating the communication configuration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, to a network node, a wakeup signal (WUS) capability that indicates support for receiving a WUS that indicates a communication configuration that comprises at least one of: a first quantity of uplink (UL) or downlink (DL) multiple-input-multiple-output (MIMO) layers, a second quantity of transmit (TX) or receive (RX) ports, or a main radio PDCCH skip configuration; receiving, from the network node, the WUS that indicates the communication configuration; and communicating with the network node based at least in part on the communication configuration indicated by the WUS.

Aspect 2: The method of Aspect 1, where the communication configuration indicates, as the first quantity of UL or DL MIMO layers, at least one of: a third quantity of downlink MIMO layers, or a fourth quantity of uplink MIMO layers.

Aspect 3: The method of any of Aspects 1-2, where the communication configuration indicates, as the second quantity of TX or RX ports, at least one of: a fifth quantity of TX ports, or a sixth quantity of RX ports.

Aspect 4: The method of any of Aspects 1-3, where the communication configuration indicates an enabled state for the main radio PDCCH skip configuration, the enabled state indicating to skip at least one of: main radio PDCCH monitoring, or main radio PDCCH decoding.

Aspect 5: The method of any of Aspects 1-4, wherein the WUS capability indicates at least one of: a seventh quantity of TX or RX ports that are supported by the UE, a time offset, or a main radio PDCCH skip capability.

Aspect 6: The method of Aspect 5, wherein the time offset is scalable based at least in part on the communication configuration.

Aspect 7: The method of any of Aspects 1-6, further comprising: receiving, from the network node, a WUS configuration that is associated with an activation state of the WUS indicating the communication configuration.

Aspect 8: The method of Aspect 7, wherein the WUS configuration indicates at least one of: the activation state, a time offset difference, or a WUS main radio PDCCH skip indication state.

Aspect 9: The method of any of Aspects 1-8, further comprising: monitoring for the WUS using a WUS receiver that is different from a main radio at the UE, the WUS receiver configured to consume less power than the main radio.

Aspect 10: The method of any of Aspects 1-9, wherein communicating with the network node based at least in part on the communication configuration indicated by the WUS comprises: activating any configuration of one or more TX ports or one or more RX ports that are associated with a main radio of the UE based at least in part on the communication configuration.

Aspect 11: The method of Aspect 10, wherein the configuration includes at least one TX port of the one or more TX ports, and wherein communicating with the network node comprises: transmitting an uplink communication using the at least one TX port

Aspect 12: The method of Aspect 10, wherein the configuration includes at least one RX port of the one or more RX ports, and wherein communicating with the network node comprises: receiving downlink communication using the at least one RX port.

Aspect 13: The method of any one of Aspects 10-12, wherein communicating with the network node comprises: communicating a MIMO communication using the configuration of the one or more TX ports or the one or more RX ports.

Aspect 14: The method of any of Aspects 1-13, wherein WUS indicates to activate at least one of: a secondary cell-specific communication configuration, a secondary cell group-specific communication configuration, or a dual connectivity-specific communication configuration.

Aspect 15: A method of wireless communication performed by a network node, comprising: receiving, from a user equipment (UE), a wakeup signal (WUS) capability that indicates support for receiving a WUS that indicates a communication configuration that comprises at least one of: a first quantity of uplink (UL) or downlink (DL) multiple-input-multiple-output (MIMO) layers, a second quantity of transmit (TX) or receive (RX) ports, or a main radio PDCCH skip configuration; transmitting, to the UE, the WUS that indicates the communication configuration; and communicating with the UE based at least in part on the communication configuration indicated by the WUS.

Aspect 16: The method of Aspect 15, wherein the WUS is a low power WUS.

Aspect 17: The method of any of Aspects 15-16, where the communication configuration indicates, as the first quantity of UL or DL MIMO layers, at least one of: a third quantity of UL MIMO layers, or a fourth quantity of DL MIMO layers.

Aspect 18: The method of any of Aspects 15-17, wherein the communication configuration indicates, as the second quantity of TX or RX ports, at least one of: a fourth quantity of TX ports, or a fifth quantity of RX ports.

Aspect 19: The method of any of Aspects 15-18, where the communication configuration indicates an enabled state for the main radio PDCCH skip configuration, the enabled state indicating to skip at least one of: main radio PDCCH monitoring, or main radio PDCCH decoding.

Aspect 20: The method of any of Aspects 15-19, wherein the WUS capability indicates at least one of: a seventh quantity of TX or RX ports that are supported by the UE, a time offset, or a main radio PDCCH skip capability.

Aspect 21: The method of Aspect 20, wherein the time offset is scalable based at least in part on the communication configuration.

Aspect 22: The method of any of Aspects 15-21, further comprising: transmitting, to the UE, a WUS configuration that indicates an activation state of the WUS indicating the communication configuration.

Aspect 23: The method of Aspect 22, wherein the WUS configuration indicates at least one of: the activation state, a time offset difference, or a WUS main radio PDCCH skip indication state.

Aspect 24: The method of any of Aspects 15-23, wherein communicating with the UE comprises: receiving, from the UE, an uplink communication that is based at least in part on the communication configuration.

Aspect 25: The method of any of Aspects 15-24, wherein communicating with the UE comprises: transmitting, to the UE, a downlink communication that is based at least in part on the communication configuration.

Aspect 26: The method of any of Aspects 15-25, wherein communicating with the UE comprises: communicating a MIMO communication that is based at least in part on the communication configuration.

Aspect 27: The method of Aspect 26, wherein the MIMO communication comprises at least one of: an uplink MIMO communication, or a downlink MIMO communication.

Aspect 28: The method of any of Aspects 15-27, wherein WUS indicates to activate at least one of: a secondary cell-specific communication configuration, a secondary cell group-specific communication configuration, or a dual connectivity-specific communication configuration.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.

Aspect 30: An apparatus for wireless communication at a device, the apparatus comprising one or more memories and one or more processors coupled to the one or more memories, the one or more processors configured to cause the device to perform the method of one or more of Aspects 1-13.

Aspect 31: An apparatus for wireless communication, the apparatus comprising at least one means for performing the method of one or more of Aspects 1-13.

Aspect 32: A non-transitory computer-readable medium storing code for wireless communication, the code comprising instructions executable by one or more processors to perform the method of one or more of Aspects 1-13.

Aspect 33: A non-transitory computer-readable medium storing a set of instructions for wireless communication, the set of instructions comprising one or more instructions that, when executed by one or more processors of a device, cause the device to perform the method of one or more of Aspects 1-13.

Aspect 34: A device for wireless communication, the device comprising a processing system that includes one or more processors and one or more memories coupled with the one or more processors, the processing system configured to cause the device to perform the method of one or more of Aspects 1-13.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-13.

Aspect 36: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 14-28.

Aspect 37: An apparatus for wireless communication at a device, the apparatus comprising one or more memories and one or more processors coupled to the one or more memories, the one or more processors configured to cause the device to perform the method of one or more of Aspects 14-28.

Aspect 38: An apparatus for wireless communication, the apparatus comprising at least one means for performing the method of one or more of Aspects 14-28.

Aspect 39: A non-transitory computer-readable medium storing code for wireless communication, the code comprising instructions executable by one or more processors to perform the method of one or more of Aspects 14-28.

Aspect 40: A non-transitory computer-readable medium storing a set of instructions for wireless communication, the set of instructions comprising one or more instructions that, when executed by one or more processors of a device, cause the device to perform the method of one or more of Aspects 14-28.

Aspect 41: A device for wireless communication, the device comprising a processing system that includes one or more processors and one or more memories coupled with the one or more processors, the processing system configured to cause the device to perform the method of one or more of Aspects 14-28.

Aspect 42: An apparatus for wireless communication at a device, the apparatus comprising one or more memories and one or more processors coupled to the one or more memories, the one or more processors individually or collectively configured to cause the device to perform the method of one or more of Aspects 14-28.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
transmit, to a network node, a wakeup signal (WUS) capability that indicates support for receiving a WUS that indicates a communication configuration that comprises at least one of:
a first quantity of uplink (UL) or downlink (DL) multiple-input-multiple-output (MIMO) layers,
a second quantity of transmit (TX) or receive (RX) ports, or
a main radio PDCCH skip configuration;
receive, from the network node, the WUS that indicates the communication configuration; and
communicate with the network node based at least in part on the communication configuration indicated by the WUS.

2. The apparatus of claim 1, where the communication configuration indicates, as the first quantity of UL or DL MIMO layers, at least one of:
a third quantity of downlink MIMO layers, or
a fourth quantity of uplink MIMO layers.

3. The apparatus of claim 1, where the communication configuration indicates, as the second quantity of TX or RX ports, at least one of:
a fifth quantity of TX ports, or
a sixth quantity of RX ports.

4. The apparatus of claim 1, where the communication configuration indicates an enabled state for the main radio PDCCH skip configuration, the enabled state indicating to skip at least one of:
main radio PDCCH monitoring, or
main radio PDCCH decoding.

5. The apparatus of claim 1, wherein the WUS capability indicates at least one of:
a seventh quantity of TX or RX ports that are supported by the UE,
a time offset, or
a main radio PDCCH skip capability.

6. The apparatus of claim 5, wherein the time offset is scalable based at least in part on the communication configuration.

7. The apparatus of claim 1, wherein the one or more processors are further configured to cause the UE to:
receive, from the network node, a WUS configuration that is associated with an activation state of the WUS indicating the communication configuration.

8. The apparatus of claim 7, wherein the WUS configuration indicates at least one of:
the activation state,
a time offset difference, or
a WUS main radio PDCCH skip indication state.

9. The apparatus of claim 1, wherein the one or more processors are further configured to cause the UE to:
monitor for the WUS using a WUS receiver that is different from a main radio at the UE, the WUS receiver configured to consume less power than the main radio.

10. The apparatus of claim 1, wherein the one or more processors, to cause the UE to communicate with the network node based at least in part on the communication configuration indicated by the WUS, are configured to cause the UE to:
activate any configuration of one or more TX ports or one or more RX ports that are associated with a main radio of the UE based at least in part on the communication configuration.

11. The apparatus of claim 10, wherein the configuration includes at least one TX port of the one or more TX ports, and
wherein the one or more processors, to cause the UE to communicate with the network node, are configured to cause the UE to:
transmit an uplink communication using the at least one TX port.

12. The apparatus of claim 10, wherein the configuration includes at least one RX port of the one or more RX ports, and
wherein the one or more processors, to cause the UE to communicate with the network node, are configured to cause the UE to:
receive downlink communication using the at least one RX port.

13. The apparatus of claim 10, wherein the one or more processors, to cause the UE to communicate with the network node, are configured to cause the UE to:
communicate a MIMO communication using the configuration of the one or more TX ports or the one or more RX ports.

14. The apparatus of claim 1, wherein WUS indicates to activate at least one of:
a secondary cell-specific communication configuration,
a secondary cell group-specific communication configuration, or
a dual connectivity-specific communication configuration.

15. A method of wireless communication performed by a user equipment (UE), comprising:
transmitting, to a network node, a wakeup signal (WUS) capability that indicates support for receiving a WUS that indicates a communication configuration that comprises at least one of:
a first quantity of uplink (UL) or downlink (DL) multiple-input-multiple-output (MIMO) layers,
a second quantity of transmit (TX) or receive (RX) ports, or
a main radio PDCCH skip configuration;
receiving, from the network node, the WUS that indicates the communication configuration; and
communicating with the network node based at least in part on the communication configuration indicated by the WUS.

16. The method of claim 15, wherein the WUS capability indicates at least one of:
a third quantity of TX or RX ports supported by the UE,
a time offset, or
a main radio PDCCH skip capability.

17. The method of claim 15, wherein communicating with the network node based at least in part on the communication configuration indicated by the WUS comprises:
activating any configuration of one or more TX ports or one or more RX ports that are associated with a main radio of the UE based at least in part on the communication configuration.

18. The method of claim 17, wherein communicating with the network node comprises:
communicating a MIMO communication using the configuration of the one or more TX ports or the one or more RX ports.

19. The method of claim 15, wherein WUS indicates to activate at least one of:
a secondary cell-specific communication configuration,
a secondary cell group-specific communication configuration, or
a dual connectivity-specific communication configuration.

20. A non-transitory computer-readable medium storing a set of instructions for wireless communication, the set of instructions comprising:
one or more instructions that, when executed by one or more processors of a user equipment (UE), cause the UE to:
transmit, to a network node, a wakeup signal (WUS) capability that indicates support for receiving a WUS that indicates a communication configuration that comprises at least one of:
a first quantity of uplink (UL) or downlink (DL) multiple-input-multiple-output (MIMO) layers,
a second quantity of transmit (TX) or receive (RX) ports, or
a main radio PDCCH skip configuration;
receive, from the network node, the WUS that indicates the communication configuration; and
communicate with the network node based at least in part on the communication configuration indicated by the WUS.
